(19) United States
(12) Patent Application Publication
(10) Pub. No.: US 2015/0078002 A1
(43) Pub. Date: Mar. 19, 2015

(54) LED LIGHT HAS MORE THAN ONE OPTICS MEANS TO PROJECT LIGHT

(71) Applicant: Tseng-Lu Chien, Walnut, CA (US)

(72) Inventor: Tseng-Lu Chien, Walnut, CA (US)

(21) Appl. No.: 14/030,023

(22) Filed: Sep. 18, 2013

(51) Int. Cl. F21K 99/00; F21V 5/04; F21V 7/00

(52) U.S. Cl. CPC F21K 9/50; F21V 7/00; F21V 5/04
USPC 362/277

(57) ABSTRACT

An LED night light having different power sources including a battery, outlet plug-in power source, or interchangeable power source incorporates geometric shape optics means(es) has more than one OPTICS means(es) which has relative positions, distances, and/or orientations to create plurality of light beams Passing though by more than one OPTICS means(s), so the light beam(s) of the said LED or LEDs will pass though the said more than one optics means(es) and project to surface(s) surrounding including ceiling, walls, floor and all desire areas. At least one of the optics means has optics-properties on its surface(s) to permit the plurality of LED or LEDs light beam(s) passing through the optics means and passing though plurality optics means to create the motion or color image while incorporate with control means and IC means. The LED device has slid surface which allow the narrow housing but with maximum light-output area to offer the maximum light beams to be seen on locations because the Big Light-Output area which are bigger than the LED light device housing's cross-section surface.

The current invention are CIP of co-inventor's co-pending filing or following projection light device including:
U.S. Ser. No. ______ Multiple function LED project Light has built-In Motor means, Filed on Sep. 5, 2013
U.S. Ser. No. ______ LED light has more than one reflective means to project Light or image, Filed on Sep. 10, 2013.
U.S. Ser. No ______ LED light has kaleidoscope means, Filed on Sep. 10, 2013.
U.S. Ser. No. 13/021,124 LED light has changeable image and pattern by kaleidoscope means to project to surfaces. Filed on Feb. 4, 2011 and public on Aug. 9, 2012, 2012-0200-828.
U.S. Ser. No. 12/710,918 LED light has more than one reflector means, Now U.S. Pat. No. 8,8277,087 which similar with current invention to apply the kaleidoscope means which has more than one reflective means hereof use mirror or mirror-like means to assembly into kaleidoscope means.
U.S. Ser. No. 11/806,284 LED light has more than one optic means, now U.S. Pat. No. 7,632,004 which has use more than one optics means which similar with current invention to apply the optics means in front of or back of back of kaleidoscope means to create, adjust, magnify, reduce, enlarge the said the said image, LEDs light beams, LED lights' image, shape which including the any combination from optics lens, optics mirror, laser hologram, laser grating film, optics assembly
U.S. Pat. No. 7,455,444 LED light has more than one LED light source, the current invention use more than one LEDs for matrix arrangements with Circuit means, IC means, sensor means, switch means, brightness control means, color mix means, color selection means, color freeze means, motor means, gear means, turn-On and turn-Off means to make the certain number of LEDs turn-On with desired color, brightness, light brightness output, light functions, matrix combinations, motor means, rotating means, gear set means to pass though the said kaleidoscope means, optics means, laser mans, motor means, gear means, to has desired light patterns.
U.S. Ser. No. 12/948,953, U.S. Ser. No. 12/938,564 U.S. Ser. No. 12/886,832, U.S. Ser. No. 12/876,507, U.S. Ser. No. 12/771,003, U.S. Ser. No. 12/624,621, U.S. Ser. No. 12/914,584, U.S. Ser. No. 12/318,471, U.S. Ser. No. 12/318,470, U.S. Ser. No. 12/834,435 and also is continuous filing for co-inventor's prior filing cases as below issued patents:
U.S. Ser. No. 12/292,153 (now is U.S. Pat. No. 7,871,192),
U.S. Ser. No. 12/232,505 (now is U.S. Pat. No. 7,832,917),
U.S. Ser. No. 12/318,473 (now is U.S. Pat. No. 7,832,918). LED light has laser means
U.S. Ser. No. 12/624,621 (Now is U.S. Pat. No. 8,303,150) LED project light for Seasonal items
U.S. Ser. No. 12/771,003 (now is U.S. Pat. No. 8,408,736) Light device has More than one project means.
U.S. Ser. No. 12/876,507 (now U.S. Pat. No. 8,083,377) Light device has projection function with focus adjustable and project means can change position
U.S. Ser. No. 12/886,832 Digital data projection Light device, Sep. 8, 2010 filed
U.S. Ser. No. 12/938,564 Laser projection light device, Nov. 4, 2010 filed
U.S. Ser. No. 12/948,953 LED light has time projection. Nov. 13, 2010 filed.
U.S. Ser No. 13/021,107 LED light has 3Dimensional projection, Feb. 4, 2011 filed.

Above listed Projection light device total has (9) projection light device are parent filing cases as CIP filing of the current invention.

### BACKGROUND OF THE INVENTION

Further more the Co-invention also has co-pending filing for light device has interchangeable power source for Wall outlets AC power and Energy storage means (Direct current) including the all kind of combination selection from prong mean, extension cord, adaptor, transformer, Solar, wind power, Batteries, chemical power, biologic power all can be interchange or for any AC or battery power for Desk Top and Plug In type of current invention of project light device has build-in kaleidoscope means. The interchangeable co-filing cases as below:
U.S. Ser. No. 12/318,473,
U.S. Ser. No. 12/940,255 (Now U.S. Pat. No. 8,231,246) #FF-1

So the current invention are CIP for variety of co-inventor's co-pending or co-patents as above listed including: (1) Project light device (2) More than 1 optics means (3) More than 1 LEDs (4) More than 1 reflective means (5) Interchangeable power source (6) Laser Means (7) Adjustable focus and position changeable (8) motor & Gear set for moving adjustable.

This application has subject matter in common with U.S. patent application Ser. Nos. 12/710,561; 12/711,456; 12/771,003; 12/624,621; 12/622,100; 12/318,471; 12/318,470; 12/318,473; 12/292,153; 12/232,505; 12/232,035; 12/149,963; 12/149,964; 12/073,095; 12/073,889; 12/007,076; 12/003,691; 12/003,809; 11/806,711; 11/806,285; 11/806,284; 11/566,322; 11/527,628; 11,527,629; 11/498,874; 12/545,992; 12/806,711; 12/806,285; 12/806,284; 12/566,322; 12/527,628; 12/527,629; 12/527,631; 12/502,661; 11/498,881; 11/255,981; 11/184,771; 11/152,063; 11/094,215; 11/092,742; 11/092,741; 11/094,156. 11/094,155. 10/954,189; 10/902,123, 10/883,719; 10/883,747; 10/341,519; 12/545,992; and 12/292,580.

In particular, the following applications show light devices that have at least some features in common with included or optional features of the LED light device of the present invention: Ser. No. 12/710,561 (“LED power failure Light”); Ser. No. 12/711,456 (“LED light device has special effects”); Ser. No. 12/771,003 (“LED light device has more than 1 reflective means for plurality of image”); Ser. No. 12/624,621 (“projection device or assembly for variety of LED light”); Ser. No. 12/622,000 (“Interchangeable Universal Kits for all LED light”); Ser. No. 12/318,471 (“LED night light with pinhole imaging”); Ser. No. 12/318,470 (“LED night light with Projection features”); Ser. No. 12/318,473 (“LED night light with laser or hologram element”); Ser. No. 12/292,153 (“LED night light with Projection or imaging features”); Ser. No. 12/232,505 (“LED night light with Projection features”); Ser. No. 12/149,963 (“Removable LED light device”); Ser. No. 12/149,964 (“Surface Mounted Device with LED light”); Ser. No. 12/073,095 (“LED Track light device”); Ser. No. 12/073,889 (“LED light with changeable position with Preferable power source”); Ser. No. 12/007,076 (“LED light with changeable geometric system”); Ser. No. 12/003,691 (“LED light with changeable geometric dimension features”); Ser. No. 12/003,809 (“LED light with changeable features”); Ser. No. 11/806,711 (“Multiple LED light with adjustable angle features”); Ser. No. 11/806,285 (“LED Night light with outlet device”); Ser. No. 11/806,284 (“LED Night light with more than 1 optics means”); Ser. No. 11/527,628 (“Multiple function Night light with air freshener”); Ser. No. 11/527,629 (“LED Night light with interchangeable display unit”); Ser. No. 11/498,874 (“Area illumination Night light”); Ser. No. 11/527,631 (“LED Time piece night light”); Ser. No. 12/545,992 (“LED time piece Night light”); Ser. No. 12/292,580 (“LED Time Piece Night light”); Ser. No. 11/498,881 (“Poly Night light”); Ser. No. 11/255,981 (“Multiple light source Night Light”); Ser. No. 11/184,771 (“Light Device with EL elements”); Ser. No. 11/152,063 (“Outlet adaptor with EL”); Ser. No. 11/094,215 (“LED night light with liquid medium”); Ser. No. 11/094,215 (“LED Night light with Liquid optics medium”); Ser. No. 11/092,741 (“Night light with fiber optics”); Ser. No. 10/883,747 (“Fiber Optic light kits for footwear”); Ser. No. 11/498,874 (“Area Illumination for LED night light”); Ser. No. 11/527,629 (“Time Piece with LED night light”); Ser. No. 11/527,628 (“Multiple Function Night light with Air Freshener”); Ser. No. 11/806,284 (“LED Night light with more than one optics mediums”); Ser. No. 11/806,285 (“LED Night Light with multiple function”); and Ser. No. 11/806,711 (“Multiple LEDs Light with adjustable angle function”).

The applications of the inventor in general all apply physics or optics theory to a night light supplied with power from an outlet, battery, solar, or other power source. The present invention uses the physics or optics theory to create a plurality of LED light images on a surface. More specifically, the current invention uses more than one reflective means to transform a single LED spot light into a plurality of images on a surface to be seen by viewer. The principles of the invention may be applied to night lights of various types, including night lights disclosed in the above-listed patents and patent applications of the inventor, which may be powered by a variety of power sources, such as an outlet, batteries, solar, wind, or chemical power sources.

Because of the persistence of vision effect, caused by the human eye response time of more than 1/24 (41367) to 1/16 (0.0625) seconds, when an object moves faster than the human eye response time, the last image will stay in the human eye and brain for an extended period of time. This theory can utilized to save power by causing an LED or LEDs to flash with a very short on-time of around 10 msec or less. This principle is similar to that of a motion picture in which, if an object in front of human eye is displayed in 16-24 pictures per second, people will think all pictures are continuous. Hence, the current invention uses a related circuit, control means, IC, and/or micro controller to cause an LED light device to blink at a rate that is much faster than 16-24 times (cycles) per second, with the LED or LEDs being turned on for 10% of each cycle and off for 90% of the cycle to save up to 90% of power consumption or increase battery life by nine times more than the full steady-ON condition. This is a significant power saving for all battery power source applications. It will be appreciated that new LEDs may be coming soon to enable the LEDs to have an even quicker response time of less than 10 msec, and possibly less than 5 msec or 2 msec, to provide even greater power saving. such adjustment of the duration of each cycle's turn-on and turn-off duration time will cause even more power saving to meet the green world concept. This is one of the very important concepts of the current invention.

Further cost saving can be achieved in the case of a battery powered unit by using a circuit with proper electric components, parts, and accessories to raise the voltage output of the batteries to trigger the LED or LEDs even though the number of batteries is less than that normally required to generate the required voltage. This can counter the tendency of people to use a large quantity of batteries and save substantial cost, which is another important advantage of the current invention.

A preferred embodiment of the current invention includes an LED night light with more than one reflective means within the geometric shape optics means that provide a plurality of LED light beams to passing through or reflecting within the more than one reflector means inside the optics means. The LED night light including at least one LED arranged on the inner of the partial transparency geometric optics means has more than one of the said reflective means, at least one second reflective means within the geometric optics means which can reflect an LED light beams from its surface to 1^{st} or others reflective means surface(s) back and forth so one LED light beams been reflected and travel within the optics means and partial of LED light beam are passing though the partial transparency optics means to outside.

In this embodiment, a plurality of the LED beam can be project outside though the said surface(s). Furthermore, at least one of the reflective means may be partially transparent so that the plurality of LED light beam is passing though from the said surface(s) thereof. The other Plurality of the light beam is been reflected or retro-reflected within the other reflector means and passing though some other surface(s).

The LED or LEDs of this embodiment are preferably connected with circuit means, power means, contact means, conductive means, switch means, sensor means, motor means, spin means, rotating means, gear set means, speed control means, printed circuit means, integrated circuit (I.C.) means and/or related parts and accessories to cause the LED or LEDs to turn on and off according to a predetermined time period, functions, colors, and/or effects to provide a desired lighting performance.

In the above-described preferred embodiment, the reflective means may be a mirror, chrome finished piece, polished piece, double-side mirror, or any surface having reflective and passing though both optics properties suitable to the current invention.

The partial transparent or see-though properties can be provided by a transparent piece, colored transparent piece, or any other piece that allows light beams to pass there through. A power source of this embodiment can be in the form of an outlet, batteries, solar power, chemical power, or wind power.

The LED or LEDs can be selected from any combination of single color, multiple color, multiple piece, standard, and special LED assemblies, LED number from 1 to N (N can be any number) to arrange in desire matrix spacing which available on the market.

Finally, the distance, position, orientation of the reflective means may be changed basing on the selected geometric shape of optics means. The LED or LEDs arrangement for different of LED number, position, color, IC chip, control means, circuit means, functions, and brightness can create a desire plurality of light patterns, show, color changing, images changing, moving effects to people to be seen on surrounding surface(s) including walls, ceiling, floor, or desire surface(s).

The said geometric optics means can has any shape with multiple construction and the said the geometric optics means has desire combination selected from the passing though lens, reflective lens, convex lens, concave lens, laser lens, hologram lens on the inner or outside surface or all side of the surface to make certain light effects.

According to another preferred embodiment of the invention, an LED light device having power saving features includes at least one LED or LEDs for a light source, at least one housing having space to install circuit means, conductive means, electric components parts and accessories, switch means, sensor means, an integrated circuit (IC), and/or a micro controller to connect with a conventional market-available power source to cause the LED or LEDs to turn on and turn to provide predetermined functions or effects, with a predetermined duty cycle, color, and/or brightness.

The power-saving features are obtained by using the control means to cause the LED or LEDs turn-on for only a certain percentage of each cycle. In particular, the turn on time is selected to meet the persistence of vision of the human eye, so as to take advantage of the human eye's response time of 1/24 to 1/16 second so that the blinking LED or LEDs looks as if it were continuously on.

According to yet another embodiment of the invention, an LED light device having cost saving features includes at least one LED or LEDs as a light source, at least one housing having space to install circuit means, conductive means, electric components parts and accessories, switch means, sensor means, an integrated circuit (IC), and/or a micro controller to connect with a conventional market-available power source, preferably batteries, to cause the LED or LEDs to turn on and turn off according to a predetermined function or effects, duty cycle, color, and/or brightness.

In this embodiment, cost saving is obtained by providing batteries having a total voltage that is less than the LED trigger voltage and by providing electric components and related parts and accessories to increase the voltage output of the batteries to greater than the LED trigger voltage.

As noted above, the current invention uses geometric shape optics-means has built-in more than one reflective means to create a plurality of LED light beam passing though, reflect, retro-reflect by the more than one of reflective means. The relative distance, position, and/or orientation of the more than one reflective means (and optional additional) reflective means will result in different light beam performance. This is a very low cost and simple way to make a splendid and eye catching light projection unit for people, with any desired power source such as a battery, USB power, outlet power, generator power, chemical power, solar power, wind power or other equivalent power source from the marketplace.

### BRIEF DESCRIPTION OF THE DRAWINGS

FIG. 1 and FIG. 1-1 and FIG. 1-2: shows a first preferred embodiment of the current invention has prong means with more than one of geometric optics-means to cause a plurality of light emit out to project the images to be seen by a viewer. It also disclosure the interchangeable power source, USB wire or other power source for the current invention. a first preferred embodiment of the current invention has DC power-means or USB Power or ineterchageable power source

FIG. 2 and FIG. 2-1 and FIGS. 2-2 and 2-3 shows a first preferred embodiment of the current invention has AC power-means or other power source for DeskTop application of current invention with more than one of geometric optics-means to cause a plurality of light emit out to project the images to be seen by a viewer. Also teach the variety of added functions may fit within the spacing for the LED light because under the LEDs has plenty of space to add more added functions from electric device, digital device, communication device, computer device, consumer electric device categories.

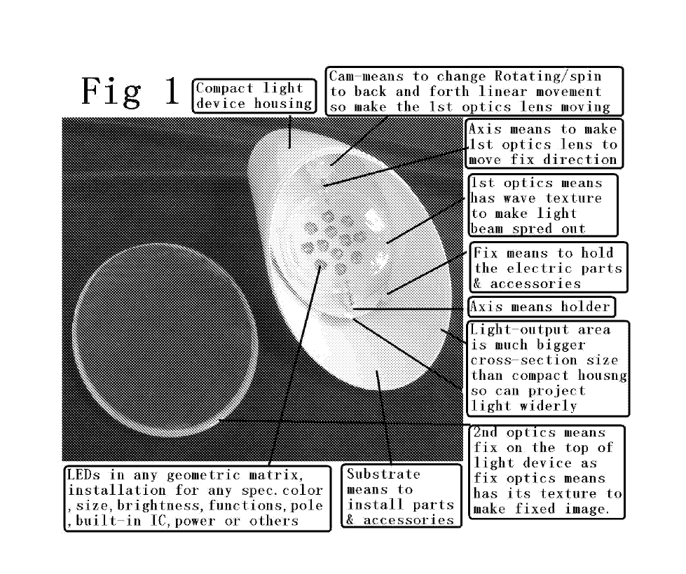

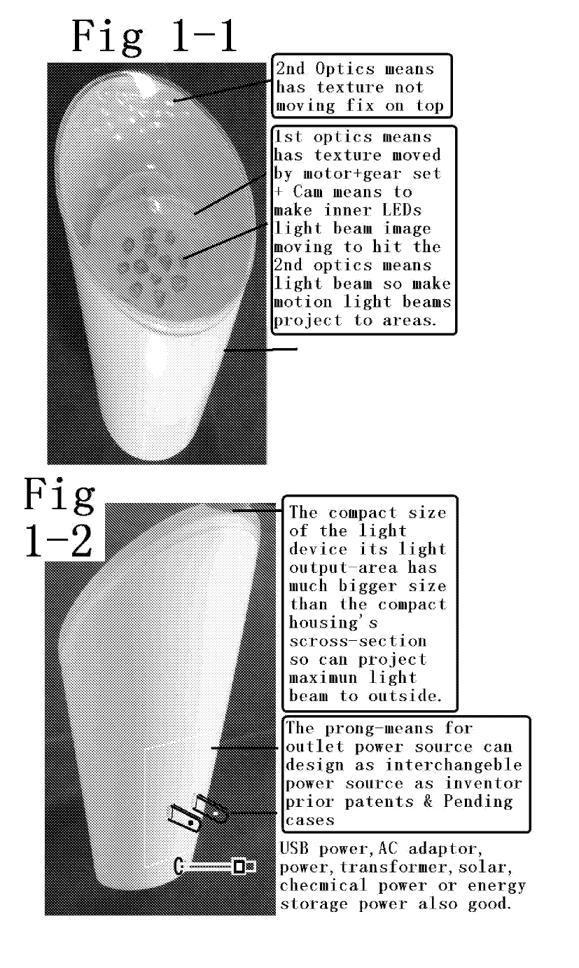

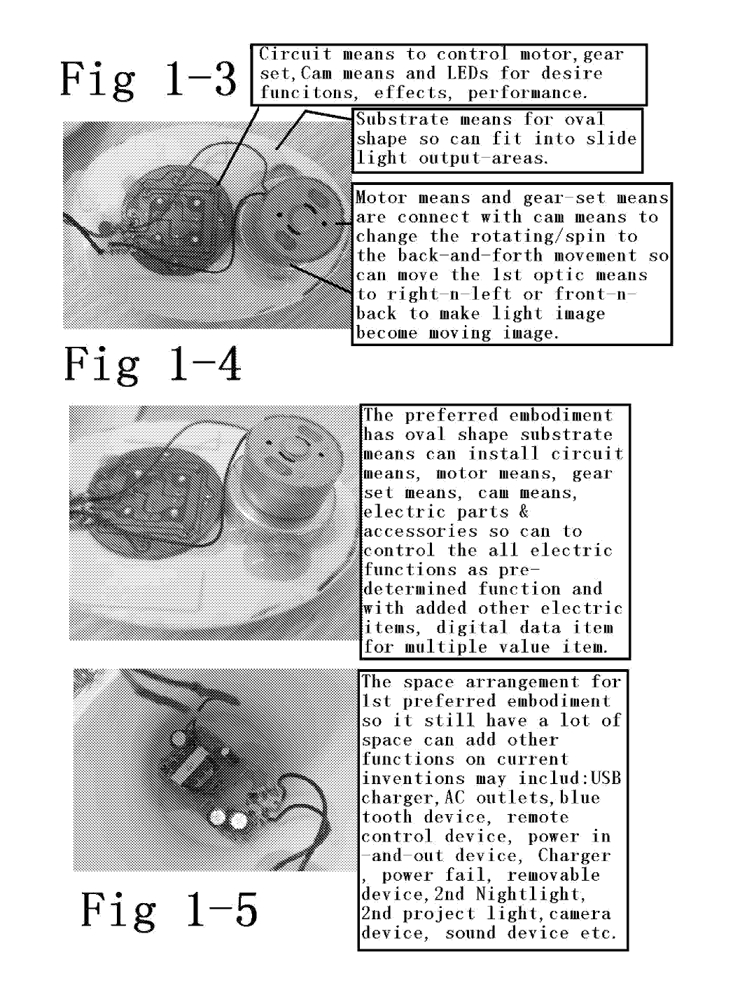

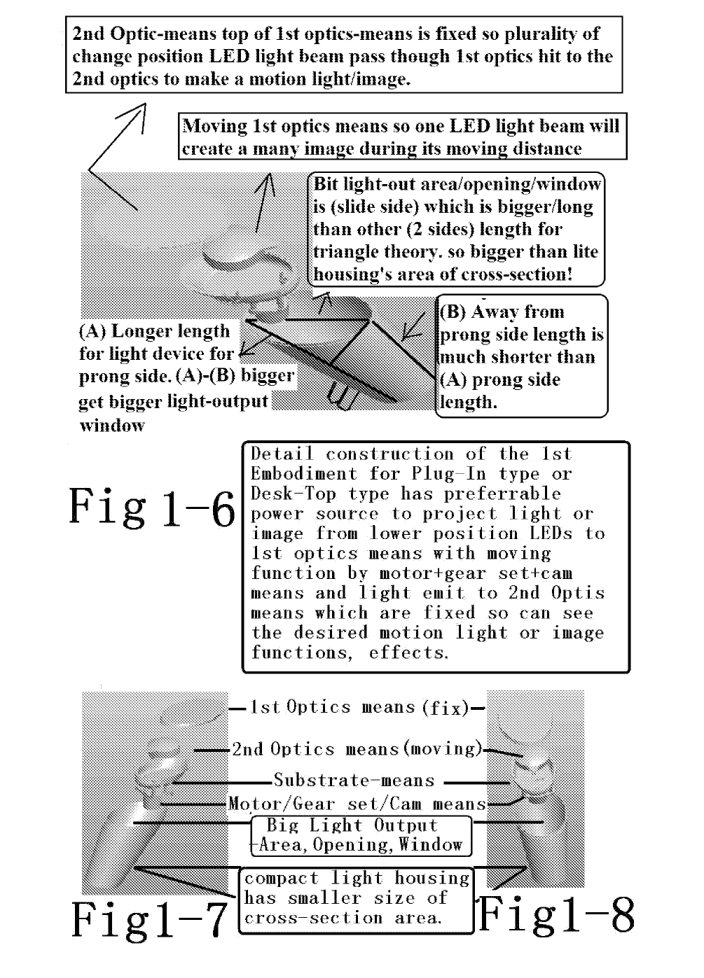

FIG. 1-3 and FIG. 1-4 and FIG. 1-5 shows with preferred parts & accessories assembly for 1st Embodiment.

From FIG. 1-6 and FIG. 1-7 and FIG. 1-8 shows the 1st preferred embodiment's details parts name and comparison drawing for different viewing angle. Also, more details for the Big Light-Output area/opening/window which are much bigger than the LED light housing's cross section size.

### DETAILED DESCRIPTION OF THE PREFERRED EMBODIMENTS

From FIG. 1 can see the LED light has more than one optics means to project light which has (1) Cam-means to change Rotating/spin to back and forth linear movement so make the 1st optics lens moving (2) Compact light device housing (3) Axis means to make 1^{st} optics lens to move fix direction (4) 1st optics means has wave texture to make light beam spread out to many direction to has the 1^{st} image project to the desired surface (5) Fix means to hold the electric parts & accessories including the substrate for the LEDs, 1^{st} optics lens, motor means, gear set means, circuit means, cam means, axis means, IC means, conductive means, wires, holder means, or other parts & accessories needed for the design (6) Axis means holder to hold the elongate axis which let install the 1^{st} optics means/lens to make the 1^{st} optics means/lens to move back-and-forth under predetermined directions so can make image moving effects while incorporate with motor means, gear set means, cam means and other parts & accessories for proper design the Rotating RPM with gear sets to meet requirement (7) Light-output area is much bigger cross-section size than compact housing so can project light wider to as big size as possible to cover majority of ceiling, walls, or any surfaces needed to be projected light beams (8) 2nd optics means fix on the top of light device as fix optics means has its texture to make fixed image. So work with the moving 1^{st} optics means's moving image with 2^{nd} optics means fix image so it can create the motion effects such as water wave, ocean wave, storm wave, . . . (9) Substrate means to install parts & accessories as above discussed (10) LEDs LEDs in any geometric matrix, installation for any spec.color, size, brightness, functions, pole, built-in IC, power or others LEDs as requirement.→These are parts of the preferred embodiment for the main construction to make LED light project light has more than one optics means for desired arrangement such as this embodiment has built-in motor means, gear set means, Cam means to make one optics leans moving back--&- forth to make moving light image and incorporate the 2^{nd} optics means to make steady/fix light image so can make the motion effects image to viewers.

From FIG. 1-1 can see 2nd Optics means has texture not moving fix on top and the 1st optics means has texture moved by motor+gear set+Cam means to make inner LEDs light beam image moving to hit the 2nd optics means light beam so make motion light beams project to areas.

From FIG. 1-2 can see the compact size of the light device its light output-area has much bigger size than the compact housing's s cross-section so can project maximum light beam to outside. The prong-means for outlet power source can design as interchangeble power source as inventor prior patents & Pending caseses. The current invention also can incorporate with the preferred other power source may in any combination from the USB power, AC adaptor, power, transformer, solar, chemical power or energy storage power also good for current invention.

From FIG. 1-3 and FIG. 1-4 can see. Circuit means to control motor, gear set, Cam means and LEDs for desire functions, effects, performance. Substrate means for oval shape so can fit into slide light output-areas. Motor means and gear-set means are connect with cam means to change the rotating/spin to the back-and-forth movement so can move the 1st optic means to right-n-left or front-n-back to make light image become moving image.

From FIG. 1-4 can see The preferred embodiment has oval shape substrate means can install circuit means, motor means, gear set means, cam means, electric parts & accessories so can to control the all electric functions as predetermined function and with added other electric items, digital data item for multiple value item.

From FIG. 1-5: Can see how to install the substrate means and parts & accessories which may selected from group combination including motor means, gear set means, cam means, axis means, axis holder, 1st optics means, LEDs, Circuit means, conductive means, wire means, switch means, sensor means, remote means, prong means, USB wire means, USB plug & receptacle means, interchangeable power source means, AC power means, Transformer power means, adaptor means, solar power means, Wide light output area means, 2^{nd} optics means, 2^{nd} LED light arrangement, Night light, Power failure light, Remote control power source mans, USB charge means, AC outlets means and any other functions can add on the current inventions to add the value of products selected from electric functions, digital data function, power input & output functions, blue tooth functions, remote control function device(s) all fall inside the current claims. From the FIG. 1-5 can know The space arrangement for 1st preferred embodiment so it still have a lot of space can add other functions on current inventions may include: USB charger, AC outlets, blue tooth device, remote control device, power in-and-out device, Charger, power fail, removable device, 2nd Nightlight, 2nd project light, camera device, sound device etc.

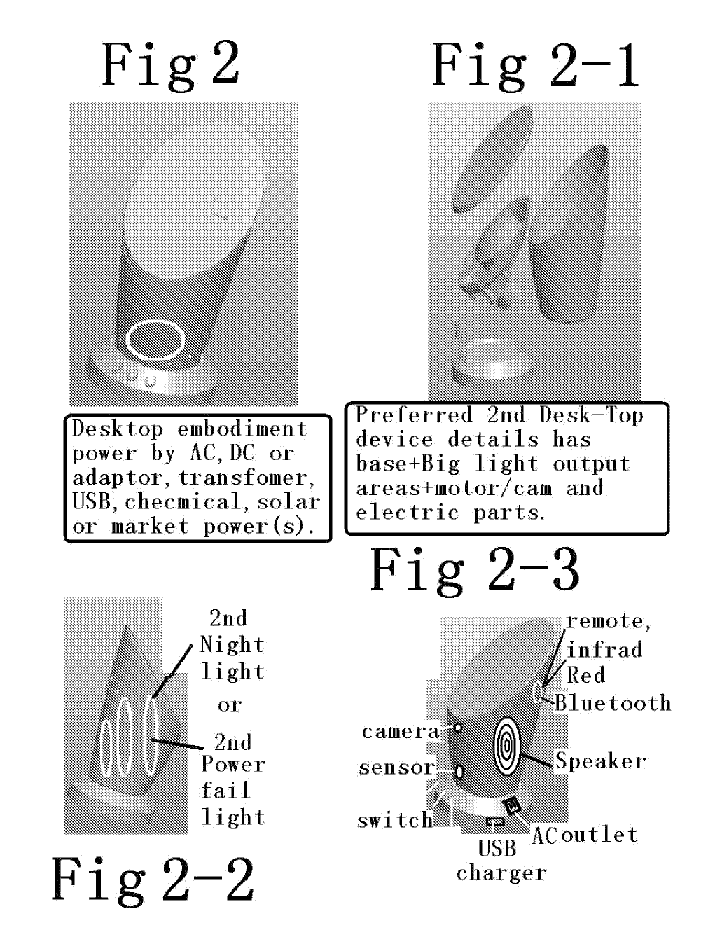

From FIG. 2 and FIG. 2-2 and FIG. 2-3 can see Desktop embodiment power by AC, DC or adaptor, transfomer, USB, chemical, solar or market available power(s). Because the light output-areas need as large as possible so the said LED light will have some more space under the substrate-means so can add the other electric functions device may selected from group consideration including speaker, audit device, video device, camera device, recorder device, speaker, sensor means, switch means, remote control device, Bluetooth device, power device, USB charger device, AC outlets power device, digital data storage device, memory card device, memory storage device, energy storage device, batteries, transformer, adaptor, receptacle, outlets, adaprot, receiving device, sound device, speaker, night light device, power fail light device, water lighting device (Water dance, Water wave), Project device, light show device, project means, optics means, optics device, communication device to add on the current LED light has more than one Optics means to project light so can become multiple functions device which the added functions may in categories of electric, digital data device, communication device, computer related device, cellar phone related device and not limited to for current invention discussion. It is appreciated the co inventor's prior arts and co-pending filing still fall withih the scope of claims and discussion and concepts. Any equivalent function, alternative skills, update method still appreciated as the current invention as prior art.

From FIG. 2-1 can see Preferred 2nd Desk-Top device details has base+Big light output areas+motor/cam and electric parts & accessories to the LEDs light beam though the 1^{st} and 2^{nd} optics means within the tube-means to project light image to all desired areas from the Top big light output-areas which are much bigger than the LED light housing cross-section size.

From FIG. 1-6, 1-7, 1-8 disclosure the Detail construction of the 1st Embodiment for Plug-In type or Desk-Top type has preferrable power source to project light or image from lower position LEDs to 1st optics means with moving function by motor+gear set+cam means and light emit to 2nd Optis means which are fixed so can see the desired motion light or image functions, effects. From FIG. 1-6 show the Big Light-Output area/opening/windows

Which has bigger size than the LED light housing's cross section. This is the simple can explain from the Mathmatic and Physics theory (Slide) is bigger than the (other 2 sides length) for a triangle theory. The Light-output area/opening/window need as big as possible to make the more bigger image/light project through the Tube-means to the ceiling, walls. This is current invention required. The said LED light has longer length on the wall side and shorter length on the away from wall side. The bigger length difference will get more large (Slide area/opening/window) so can project more light to more wider areas. This is the current invention very important to get (1) As big as possible for Light-Output area/opening/window so can project light to as larger as possible (2) The LED light unit has longer length on wall side and shorter length for LED light away from the wall side (3) The LED light has as compact as possible for housing but as larger as possible of the Light-output area/opening/window. This is the current invention make major features than Any other bulky or Bow like prior arts.

The LED project light has more than one Optics-means which has the Plug-In type has the prong means to connect with outlets from wall, extension cord, power stating, desk lamp outlets receptacles. The LED project light can project the light image to ceiling, walls, floor from the more than one optics-means construction. The optics-means has more than one Optics lens construction basing on the inner or outside has preferred texture so each become a optics-lens. The more than one of optics-means can project a splendid color image to all surrounding area because the current invention has construction of
(1) the inner built-in more than one LEDs. The LEDs may selected from group of color, specification, size, functions and each LED can has its emit direction, orientation, angle to anywhere because has more than one Optics-means as inventor's prior patented claims so the each LED light has different light emit direction even LED light emit angle is narrow but after the light beam been under more than one optics means, then, the light will come out from Big light-output areas/opening/windows . . . .
(2) This is the result basing (1) More than one LEDs (2) more than one optics-means (3) Interchangeable power source (4) as inventor's all prior patents and co-pending all LED project light concept as above and below listed (9) co-pending and issued Prior arts.

Ser. No. 12/318,471, U.S. Ser. No. 12/318,470, U.S. Ser. No. 12/834,435 and also is continuous filing for co-inventor's prior filing cases as below issued patents:
U.S. Ser. No. 12/292,153 (now is U.S. Pat. No. 7,871,192),
U.S. Ser. No. 12/232,505 (now is U.S. Pat. No. 7,832,917),
U.S. Ser. No. 12/318,473 (now is U.S. Pat. No. 7,832,918). LED light has laser means
U.S. Ser. No. 12/624,621 (Now is U.S. Pat. No. 8,303,150) LED project light for Seasonal items
U.S. Ser. No. 12/771,003 (now is U.S. Pat. No. 8,408,736) Light device has More than one project means.
U.S. Ser. No. 12/876,507 (now U.S. Pat. No. 8,083,377) Light device has projection function with focus adjustable and project means can change position
U.S. Ser. No. 12/886,832 Digital data projection Light device, Sep. 8, 2010 filed
U.S. Ser. No. 12/938,564 Laser projection light device, Nov. 4, 2010 filed
U.S. Ser. No. 12/948,953 LED light has time projection. Nov. 13, 2010 filed.
U.S. Ser No. 13/021,107 LED light has 3Dimensional projection, Feb. 4, 2011 filed.

Above listed Projection light device total has (9) projection light device are parent filing cases as CIP filing of the current invention.

From FIG. 1, FIG. 1-1, 1-2 show the Alternative Current (AC) power units which has the AC adaptor, transformer, AC wires to connect with units to get make the LED project light to have splendid project light image to be seen.

From FIG. 2, FIG. 2-1, FIG. 2-2, FIG. 2-3 and Show the Direct Current (DC) power unit which can have power from any Direct current device such as batteries, energy storage means, solar power, wind power, chemical power.

It is appreciated for the Interchangeable power source as the inventor prior art as above listed U.S. Pat. No. 8,434,927.

From FIG. 1, FIG. 1-1, 1-2 show the Plug-In type LED light device with base are install on the Plug-In housing to make the Alternative Current (A.C.) to drive the inner circuit means, LEDs, Sensor means, switch means, control means, and optional motor means to project the image to ceiling/walls/floor has plenty of color and moving (If add the motor means).

Although specific preferred embodiments of the current invention are described above, it is to be appreciated that all alternative, equivalent, same-function and/or same-skill-or-theory variations, modifications, replacements, arrangements, or constructions may still fall within the current scope of the invention.

1. An LED light having more than one Optics means to project Light or image comprising:
at least one LED;
at least one of partial transparency geometric shape of optics means has at least one of surface means has optics-properties surface; and
The said Optics means having an optics-properties surface to make pre-designed amount of LED(s)'s light beam pass or change directions though from the said LED or LEDs. The said optic-means also has more than one of light beam passing though surface(s) to allow light beam passing through and project to surrounding surface(s) including ceiling, walls, other surfaces(es) while install the said LED light on desk-top or plug-into wall outlets or extension cords or connect with the power source.
The LED or LEDs can be selected from any combination of single color, multiple color, multiple piece, standard, and special LED assemblies, LED number from 1 to N (N can be any number) to arrange in desire matrix spacing which available on the market.
The LED or LEDs are preferably connected with parts & accessories in any combination from circuit means, power means, prong means, USB wire means, battery means, AC power means, contact means, conductive means, switch means, sensor means, motor means, spin means, rotating means, gear set means, cam means, speed control means, printed circuit means, integrated circuit (I.C.) means, tube means, axis means, substrate means, and/or related parts and accessories to cause the LED or LEDs to turn on and off according to a predetermined time period, functions, colors, and/or effects to provide a desired lighting performance.
The said LED light may incorporated other added functions may selected from group combination from including speaker, audit device, video device, camera device, recorder device, speaker, sensor means, switch means, remote control device, Bluetooth device, power device, USB charger device, AC outlets power device, digital data storage device, memory card device, memory storage device, energy storage device, batteries, transformer, adaptor, receptacle, outlets, adaprot, receiving device, sound device, speaker, night light device, power fail light device, water lighting device (Water dance, Water wave), Project device, light show device, project means, optics means, optics device, communication device to add on the current LED light has more than one Optics means to project light so can become multiple functions device which the added functions may in categories of electric, digital data device, communication device, computer related device, cellar phone related device
The improvement including:
The said LED light has a big light output-areas than the LED light's housing cross-section size which big light-out area or opening or window can allow maximum light beam to project though the tube-means from more than one of the LEDs though more than one optics means.
The said LED light project light or image from LED light source(s) emit light beam passing though the more than one Optics-means and at least one of Optics means is fixed and at least one of the Optics means is movable to make the project light or image has motion effects.

2. An LED light has more than one Optics means to project light or image as recited in claim 1, wherein said Optics means is selected from the group consisting of a texture lens, raindom reflective lens, convex lens, optics lens, mirror, chrome-finished piece, fine-polished piece, and double-sided mirror.

3. An LED light has more than one Optics means to project light or image as recited in claim 1, wherein said LEDs installed below than more than one optics means.

4. An LED light has more than one Optics means to project light or image as recited in claim 1, wherein said power source is selected from the group consisting of an outlet, batteries, solar power, chemical power, and wind power to provide electricity to drive said at least one LED to emit light beams.

5. An LED light has more than one Optics means to project light or image as recited in claim 1, wherein additional motor means and gear set means and cam means to make rotating or spin to the front-back or right-left movement within the LED light to make the projected Light or Image has Moving/motional functions, effects, performance.

6. An LED light has more than one Optics means to project light or image as recited in claim 1, wherein said at least one of Optics means is fix on Top or near the Top area to work together with lower installation of the said the other movable, moving optics means.

7. An LED light has more than one Optics means to project light or image as recited in claim 1, wherein said the LED light has projection LED light beams to surface which the said LED light is one Desktop or plug-in type which are connect power from Wall outlet, receptacles, extension cord, Power strip or cigarette light application.

8. An LED light has more than on Optics means to project light or image as recited in claim 1, wherein said the geometric optics means has desire combination selected from the passing though lens, reflective lens, convex lens, concave lens, random reflective lens, texture lens, laser lens, hologram lens on the inner or outside surface or all side of the surface to make certain light effects.
